(19) United States
(12) Patent Application Publication
(10) Pub. No.: US 2006/0212289 A1
(43) Pub. Date: Sep. 21, 2006

(54) Apparatus and method for converting voice packet rate

(76) Inventors: Geun-Bae Song, Suwon-si (KR); Ho-Chong Park, Seongnam-si (KR); Jae-Bum Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/331,363

(22) Filed: Jan. 13, 2006

(30) Foreign Application Priority Data
Jan. 14, 2005 (KR) 2005-3595

(51) Int. Cl. G10L 19/08

(52) U.S. Cl. 704/221

(57) ABSTRACT

Provided is a voice packet rate converting method and apparatus. The rate of at least one first element of an input voice packet compressed at a first rate is converted to a second rate at a PCM level, and the rate of a second element of the input voice packet is converted to the second rate at a parameter level. An output voice packet compressed at the second rate is generated by combining the first element and second elements at the second rate.

### CROSS-REFERENCE TO RELATED PATENT APPLICATION

This application claims the benefit under 35 U.S.C. § 119(a) of Korean Patent Application No. 2005-3595, filed on Jan. 14, 2005, in the Korean Intellectual Property Office, the entire disclosure of which is hereby incorporated by reference.

### BACKGROUND OF THE INVENTION

1. Field of the Invention

The present invention relates to voice signal processing. More particularly, the present invention relates to an apparatus and method for converting the data rate of digital voice packets.

2. Description of the Related Art

A variable-rate voice coder supports various data rates for creating voice packets. An exemplary variable-rate voice coder is a Code Excited Linear Prediction (CELP) encoder such as the Qualcomm-Code Excited Linear Prediction (QCELP) and Enhanced Variable Rate Codec (EVRC), both of which are used in Code Division Multiple Access (CDMA) systems. A variable-rate voice coder compresses or decompresses a voice packet rate according to the characteristics of an input voice signal or a system-requested data rate. QCELP and EVRC can generate voice packets at a rate of ½, ¼ or ⅛ a full rate.

CELP-based voice coders such as QCELP or EVRC are the type of voice coders used most often. This coding technology encodes only non-redundant information by comparing the current input voice signal with the previous input voice signal. The coded information is a Linear Prediction Coefficient (LPC) filter parameter, a pitch filter parameter, and a codebook parameter. An LPC filter is known as a Formant filter.

A digital communication system needs a packet rate converter for converting a high-rate compressed voice packet into a low-rate packet to be able to decrease the rate of the high-rate compressed voice packet when requested to do so by the system. On the other hand, since a low-rate compressed voice packet can be sent through a communication path supporting a high rate, no packet rate converter is required in this case.

FIG. 1 is a block diagram of a conventional Pulse Code Modulation (PCM)-level packet rate converter 110. Referring to FIG. 1, a decoder 112 decodes a voice packet compressed at a first rate (high rate) into a PCM signal and an encoder 114 encodes the PCM signal at an appropriate second rate (low rate), thereby creating a voice packet compressed at the second rate.

FIG. 2 is a block diagram of a conventional parameter-level packet rate converter 120. Referring to FIG. 2, a parameter-level packet rate converter 120 performs a direct rate conversion at a parameter level without using a PCM signal. A dequantizer 122 dequantizes a voice packet compressed at a first rate (high rate) into an LCP filter parameter, a pitch filter parameter, and a codebook parameter which are real values. A quantizer 124 quantizes the dequantized parameters at a second rate (low rate). In this way, a voice packet compressed at the second rate is created.

The PCM-level packet rate converter 110 illustrated in FIG. 1 ensures good voice quality, but requires a long algorithmic delay and a high degree of complexity. In contrast, despite a short algorithmic delay and a low degree of complexity, the parameter-level packet rate converter illustrated in FIG. 2 suffers from severe performance degradation in terms of voice quality.

Accordingly, there is a need for an improved apparatus and method for converting a packet rate such that good voice quality and a low degree of complexity are ensured without any algorithmic delay.

### SUMMARY OF THE INVENTION

Exemplary embodiments of the present invention address at least the above problems and/or disadvantages and provide at least the advantages described below. Accordingly, an aspect of the present invention is to provide an apparatus and method for converting a packet rate such that good voice quality and a low degree of complexity are ensured without any algorithmic delay.

According to one aspect of an exemplary embodiment of the present invention, in a method of converting the rate of a voice packet, the rate of at least one first element of an input voice packet compressed at a first rate is converted into a second rate at a PCM level, and the rate of a second element of the input voice packet is converted to the second rate at a parameter level. An output voice packet compressed at the second rate is generated by combining the first element and second elements of the second rate.

According to another aspect of an exemplary embodiment of the present invention, in a method of converting the rate of a CELP voice packet, an LPC filter parameter of an input voice packet compressed at a first rate is dequantized and quantized at a second rate. Thus, the LPC filter parameter at the second rate is output. A pitch filter parameter of the input voice packet is dequantized and then quantized at the second rate. Thus, the pitch filter parameter at the second rate is output. A codebook parameter of the input voice packet is decoded and then compressed at the second rate. Thus, the codebook parameter at the second rate is output. The LPC filter parameter, pitch filter parameter, and codebook parameter at the second rate form an output voice packet at the second rate.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram of a conventional PCM-level packet rate converter;

FIG. 2 is a block diagram of a conventional parameter-level packet rate converter;

FIG. 3 illustrates the format of a voice packet applied to an exemplary embodiment of the present invention;

FIG. 4 is a block diagram of a hybrid packet rate converter according to an exemplary embodiment of the present invention;

FIG. 5 is a block diagram of an LPC rate converter according to an exemplary embodiment of the present invention;

FIG. 6 is a block diagram of a pitch rate converter according to an exemplary embodiment of the present invention;

FIG. 7 is a block diagram of a codebook rate converter according to an exemplary embodiment of the present invention;

FIG. 8 is a flowchart illustrating a voice packet rate conversion operation according to an exemplary embodiment of the present invention; and

FIG. 9 is a flowchart illustrating a codebook rate conversion operation according to an exemplary embodiment of the present invention.

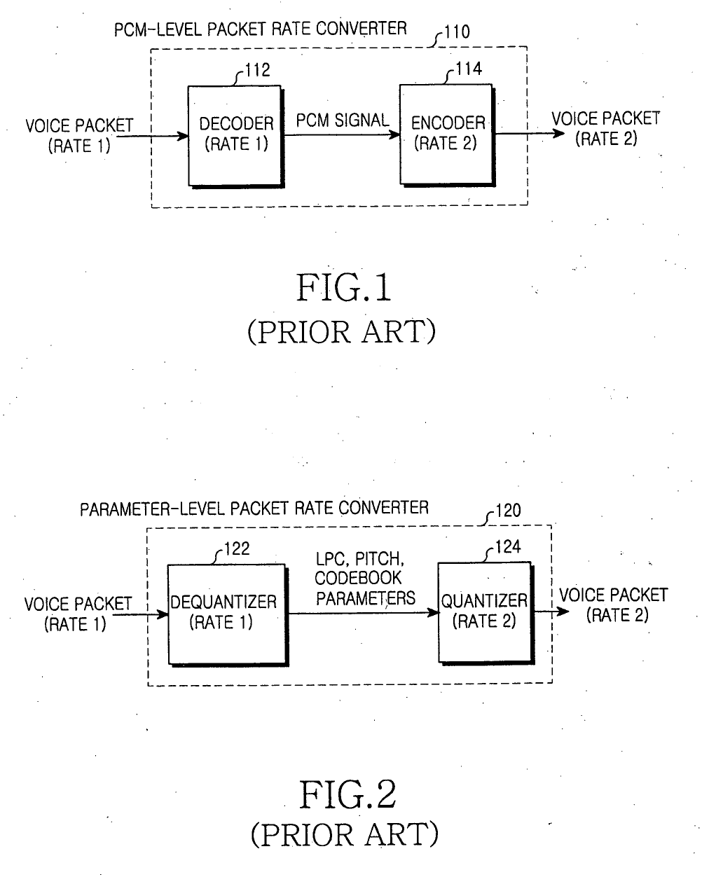

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

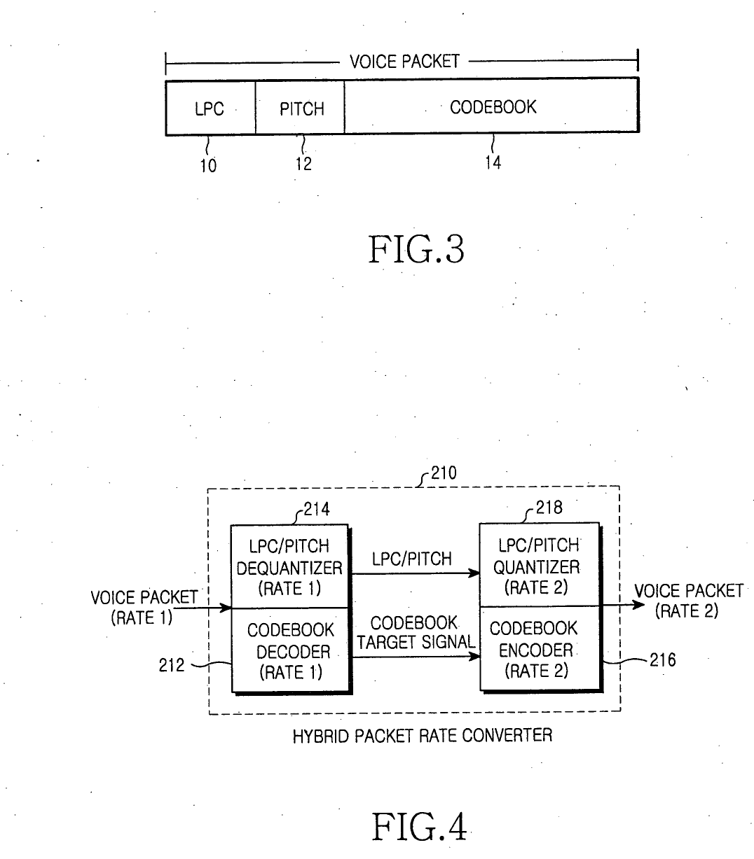

FIG. 3 illustrates the format of a voice packet applied to an exemplary embodiment of the present invention. Referring to FIG. 3, a voice packet has an LPC filter parameter 10, a pitch filter parameter 12, and a codebook parameter 14. These parameters are in the form of bit streams. The codebook parameter 14 includes a codebook gain and a codebook index that directly represents a voice signal. Typically, the number of bits used for the codebook parameter 14 is directly affected by a packet rate and is larger than the number used for the LPC filter parameter 10 and the pitch filter parameter 12. The LPC filter parameter 10 and the pitch filter parameter 12 represent the influences from a previous input signal and as such require a memory for decoding and encoding.

If a packet rate is changed, there is little difference in the decoding and coding, when compared to the codebook parameter 14, except for the number of quantized bits used and a rate per frame with regard to the LPC filter parameter 10 and the pitch parameter 12. Therefore, parameter-level packet rate conversion of the LPC filter parameter 10 and the pitch parameter 12 has no influence on performance.

Accordingly, in accordance with an exemplary embodiment of the present invention, the rate of the LPC filter parameter 10 and the pitch parameter 12 is converted at a parameter level and the codebook parameter 14 is converted at a PCM level. The combined use of the parameter-level packet rate conversion and the PCM-level packet rate conversion fulfills the desired performance with respect to algorithmic delay, complexity and voice quality.

FIG. 4 is a block diagram of a hybrid packet rate converter 210 according to an exemplary embodiment of the present invention.

Referring to FIG. 4, the hybrid packet rate converter 210 includes an LPC/pitch rate converter with a dequantizer 214 and a quantizer 218, and a codebook rate converter with a codebook decoder 212 and a codebook encoder 216. The dequantizer 214 dequantizes the LPC and pitch filter parameters 10 and 12 of an input voice packet compressed at a first rate into real-valued LPC and pitch filter parameters. The quantizer 218 quantizes the dequantized parameters at a second rate. The codebook decoder 212 decodes the codebook parameter 14 of the input voice packet compressed at the first rate into a codebook target signal. The codebook encoder 216 encodes the codebook target signal at the second rate. The quantized filter parameters and the coded codebook signal form an output voice packet compressed at the second rate.

The components of the hybrid packet rate converter 210 will be described in more detail.

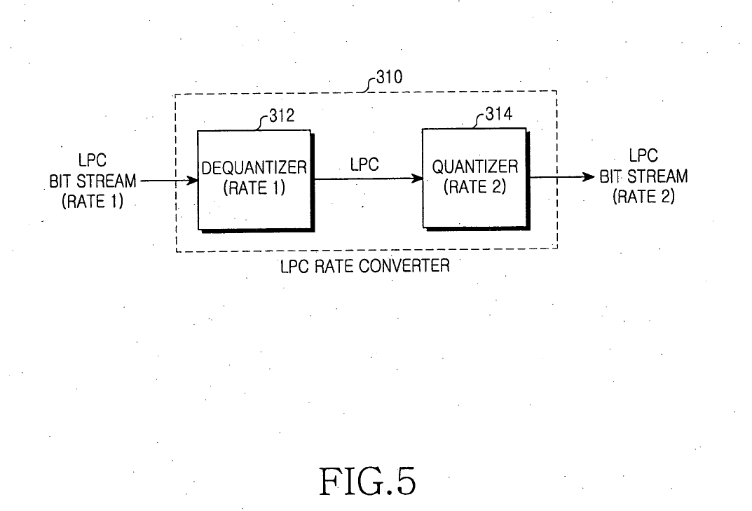

FIG. 5 is a block diagram of an LPC rate converter 310 according to an exemplary embodiment of the present invention. Referring to FIG. 5, the LPC rate converter 310 includes a rate 1 dequantizer 312 and a rate 2 quantizer 314. The dequantizer 312 dequantizes the LPC bit stream of the input voice packet compressed at the first rate. The quantizer 314 quantizes the dequantized LPC filter parameter at the second rate and outputs an LPC bit stream of the second rate.

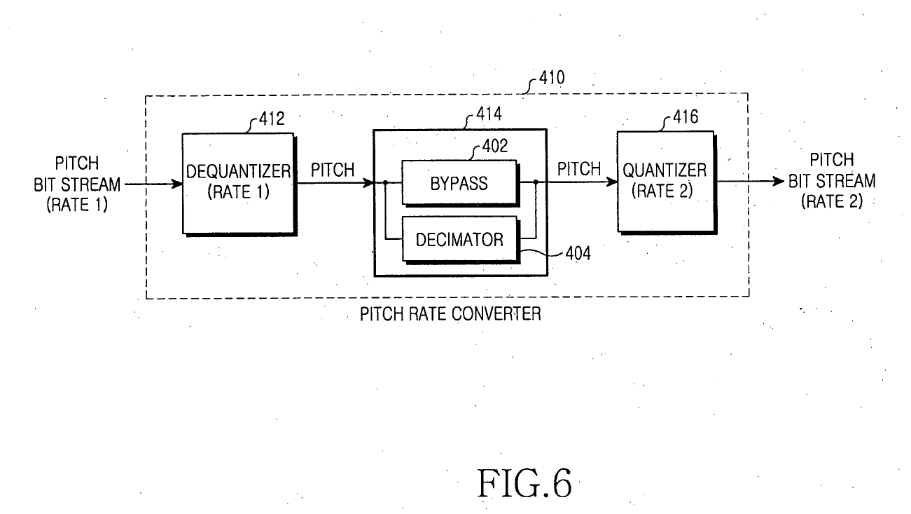

FIG. 6 is a block diagram of a pitch rate converter 410 according to an, exemplary embodiment of the present invention. Referring to FIG. 6, the pitch rate converter 410 includes a rate 1 dequantizer 412, a time-based converter 414, and a rate 2 quantizer 416.

The dequantizer 412 dequantizes the pitch bit stream of the input voice packet compressed at the first rate. The time-based converter 414 functions to match the number of pitch filter parameter values per frame at the first rate to the second rate. If the same number of pitch filter parameter values per frame are used at the first and second rates, the time-based converter 414 passes the pitch filter parameter values through a bypass 402. If more pitch filter parameter values per frame are used at the first rate than at the second rate, the time-based converter 414 decimates the pitch filter parameter values through a decimator 404. The quantizer 416 quantizes the time-based converted pitch filter parameter values at the second rate and outputs a pitch bit stream at the second rate.

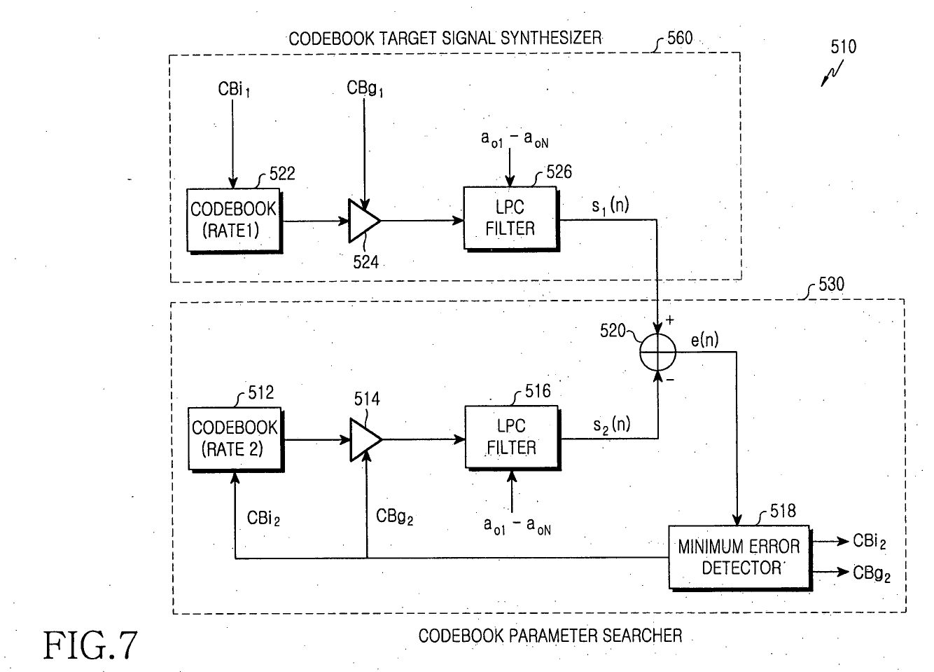

FIG. 7 is a block diagram of a codebook rate converter 510 according to an exemplary embodiment of the present invention. Referring to FIG. 7, the codebook rate converter 510 includes a codebook target signal synthesizer 560 for generating a codebook target signal s₁(n) and a codebook parameter searcher 530 for searching for a rate 2 codebook parameter. The codebook target signal synthesizer 560 has a rate 1 codebook 522, a codebook gain multiplier 524, and an LPC filter 526. The codebook parameter searcher 530 has a rate 2 codebook 512 for creating a candidate signal s₂(n), a codebook gain multiplier 514, an LPC filter 516, a combiner 520 for generating an error signal e(n), and a minimum error detector 518 for changing the candidate codebook parameter to minimize the error signal. The codebooks 512 and 522 are configured to be look-up tables listing code vectors corresponding to codebook indexes.

The codebook target signal synthesizer 560 receives a codebook index CBi₁ and a codebook gain CBg₁ as the codebook parameter of the input voice packet compressed at the first rate. The rate 1 codebook 522 outputs a first code vector corresponding to the codebook gain CBg₁. The codebook gain multiplier 524 multiplies the first code vector by the codebook gain CBg₁. For the input of the product, the LPC filter 526 generates the codebook target signal s₁(n) using the LPC filter parameter of the second rate aₒ₁ - a_{oN}. Here, n is a frame index.

The rate 2 codebook 512 outputs a second code vector corresponding to a rate 2 codebook index CBi₂ under the control of the minimum error detector 518. The codebook gain multiplier 514, multiplies the second code vector by the rate 2 codebook index CBi₂. For the input of the product, the LPC filter 516 generates the candidate signal s₂(n) using the LPC filter parameter of the second rate aₒ₁ - a_{oN}.

Finally, the combiner 520 generates the error signal e(n) by subtracting the candidate signal s₂(n) from the target signal s₁(n). The minimum error detector 518 searches for a combination of CBi₂ and CBg₂ that minimizes the error signal e(n) in the rate 2 codebook 512 by controlling the above operation. The final rate 2 codebook index and codebook gain CBi₂ and CBg₂ become the codebook parameter compressed at the second rate.

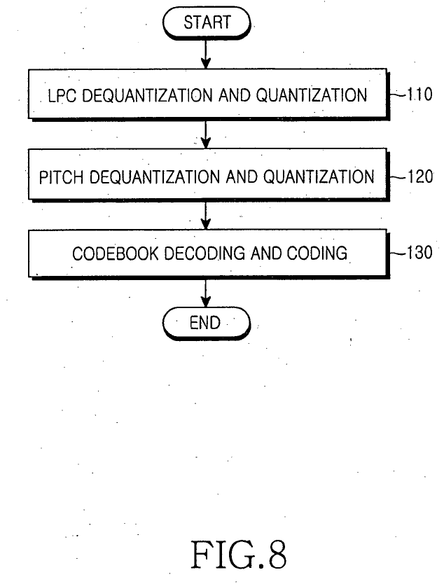

FIG. 8 is a flowchart illustrating a voice packet rate conversion operation according to an exemplary embodiment of the present invention.

Referring to FIG. 8, the LPC filter parameter of the input voice packet compressed at the first rate is converted into the LPC filter parameter of the second rate through dequantization and quantization as illustrated in FIG. 5 and in step 110 of FIG. 8. The pitch filter parameter of the voice packet is converted to the pitch filter parameter of the second rate through dequantization and quantization as illustrated in FIG. 6 and in step 120 of FIG. 8. In step 130 of FIG. 8, the codebook parameter of the voice packet is converted into the second rate through the decoding and coding illustrated in FIG. 7.

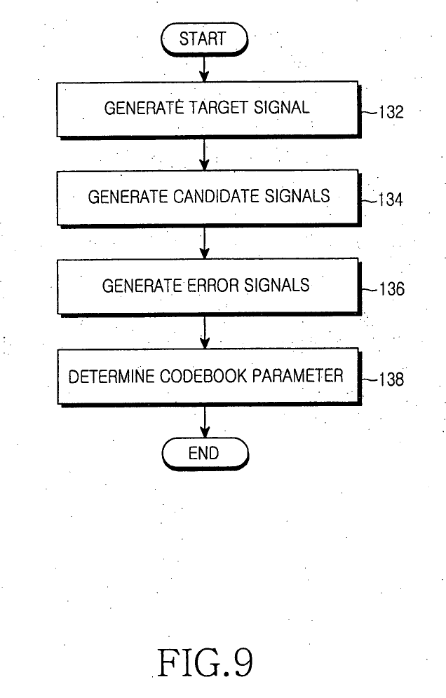

FIG. 9 is a flowchart illustrating a codebook rate conversion operation according to an exemplary embodiment of the present invention.

Referring to FIG. 9, in step 132, the input codebook parameter is converted into the codebook target signal using the filter coefficients of the LPC filter parameter obtained in step 110 of FIG. 8. The candidate signal is created by applying the filter coefficients to codebook parameters available for the second rate in step 134. In step 136, the error signal is generated, which represents the difference between the codebook target signal and the candidate signal. The codebook parameter of the second rate that minimizes the error signal is determined in step 138.

In accordance with the exemplary embodiments of the present invention as described above, the elements of a compressed voice packet are rate-converted separately at a parameter level and at a PCM level. Therefore, algorithmic delay is reduced, while ensuring good voice quality and relatively low degree of complexity.

While the invention has been shown and described with reference to certain embodiments thereof, it will be understood by those skilled in the art that various changes in, form and details maybe made therein without, departing from the spirit and scope of the invention as defined by the appended claims.

What is claimed is:

1. An apparatus for converting the rate of a code excited linear prediction (CELP) voice packet, comprising:
a linear prediction coefficient (LPC) rate converter for dequantizing an LPC filter parameter of an input voice packet compressed at a first rate, quantizing the dequantized LPC filter parameter at a second rate, and outputting the LPC filter parameter at the second rate;
a pitch rate converter for dequantizing a pitch filter parameter of the input voice packet, quantizing the dequantized pitch filter parameter at the second rate, and outputting the pitch filter parameter at the second rate; and
a codebook rate converter for decoding a codebook parameter of the input voice packet, compressing the decoded codebook parameter at the second rate, and outputting the codebook parameter at the second rate,
wherein the LPC filter parameter, pitch filter parameter, and codebook parameter at the second rate form an output voice packet at the second rate.

2. The apparatus of claim 1, wherein the pitch rate converter comprises:
a dequantizer for dequantizing the pitch filter parameter of the input voice packet and outputting pitch filter parameter values;
a time-based converter for performing time-based conversion on the pitch filter parameter values according to the second rate; and
a quantizer for quantizing the time-based converted pitch filter parameters at the second rate.

3. The apparatus of claim 2, wherein the time-based converter bypasses the pitch filter parameter values if the same number of pitch filter parameter values per frame are used at the first and second rates, and decimates the pitch filter parameters if more pitch filter parameter values per frame are used at the first rate than at the second rate.

4. The apparatus of claim 1, wherein the codebook rate converter comprises:
a codebook target signal synthesizer for generating a codebook target signal by decoding the codebook parameter of the input voice packet; and
a codebook parameter searcher for determining the codebook parameter of the second rate corresponding to the codebook target signal by searching a codebook at the second rate.

5. The apparatus of claim 4, wherein the codebook target signal synthesizer comprises:
a codebook for storing code vectors at the first rate and outputting a code vector corresponding to a codebook index included in the codebook parameter;
a codebook gain multiplier for multiplying a codebook gain included in the codebook parameter by the code vector; and
an LPC filter for filtering the product of the codebook gain and the code vector according to the LPC filter parameter at the second rate and outputting the codebook target signal.

6. The apparatus of claim 4, wherein the codebook parameter searcher comprises:
a codebook for storing code vectors corresponding to codebook indexes at the second rate and outputting candidate code vectors;
a codebook gain multiplier for multiplying code book gains at the second rate by the candidate code vectors;
an LPC filter for filtering the products of the codebook gains at the second rate and the candidate code vectors according to the LPC parameter at the second rate and outputting candidate signals;
a combiner for generating error signals by subtracting the candidate signals from the codebook target signal; and
a minimum error detector for determining a codebook index and code book gain at the second rate that is associated with minimum error signals as the codebook parameter at the second rate.

7. A method of converting the rate of a code excited linear prediction (CELP) voice packet, comprising the steps of:
dequantizing a linear prediction coefficient (LPC) filter parameter of an input voice packet compressed at a first rate, quantizing the dequantized LPC filter parameter at a second rate, and outputting the LPC filter parameter at the second rate;
dequantizing a pitch filter parameter of the input voice packet, quantizing the dequantized pitch filter parameter at the second rate, and outputting the pitch filter parameter at the second rate; and
decoding a codebook parameter of the input voice packet, compressing the decoded codebook parameter at the second rate, and outputting the codebook parameter at the second rate,
wherein the LPC filter parameter, pitch filter parameter, and codebook parameter of the second rate form an output voice packet at the second rate.

8. The method of claim 7, wherein the step of outputting the pitch filter parameter at the second rate comprises the steps of:
dequantizing the pitch filter parameter of the input voice packet and outputting pitch filter parameter values;
performing time-based conversion on the pitch filter parameter values according to the second rate; and
quantizing the time-based converted pitch filter parameters at the second rate.

9. The method of claim 8, wherein the time-based conversion step comprises the step of bypassing the pitch filter parameter values if the same number of pitch filter parameter values per frame are used at the first and second rates, and decimating the pitch filter parameters if more pitch filter parameter values per frame are used at the first rate than at the second rate.

10. The method of claim 7, wherein the step of outputting the codebook parameter at the second rate comprises the steps of:
generating a codebook target signal by decoding the codebook parameter of the input voice packet; and
determining the codebook parameter of the second rate corresponding to the codebook target signal by searching a codebook at the second rate.

11. The method of claim 10, wherein the codebook target signal generation step comprises the steps of:
outputting a code vector corresponding to a codebook index included in the codebook parameter from a code book for storing code vectors at the first rate and;
multiplying a codebook gain included in the codebook parameter by the code vector; and
filtering the product of the codebook gain and the code vector according to the LPC filter parameter at the second rate and outputting the codebook target signal.

12. The method of claim 10, wherein the codebook parameter determining step comprises the steps of:
outputting candidate code vectors from the codebook for storing code vectors corresponding to codebook indexes at the second rate;
multiplying code book gains at the second rate by the candidate code vectors;
filtering the products of the codebook gains at the second rate and the candidate code vectors according to the LPC parameter at the second rate and outputting candidate signals;
generating error signals by subtracting the candidate signals from the codebook target signal; and
determining a codebook index and code book gain at the second rate that is associated with minimum error signals as the codebook parameter at the second rate.

13. A method of converting the rate of a voice packet, comprising the steps of:
converting the rate of at least one first element of an input voice packet compressed at a first rate into a second rate at a pulse code modulation (PCM) level;
converting the rate of a second element of the input voice packet into the second rate at a parameter level; and
generating an output voice packet compressed at the second rate by combining the first element and second elements at the second rate.

14. The method of claim 13, wherein the first element comprises a pitch filter parameter.

15. The method of claim 13, wherein the first element comprises a linear prediction coefficient (LPC) filter parameter.

16. The method of claim 15, wherein the parameter-level rate conversion step comprises the steps of:
dequantizing an LPC bit stream of the input voice packet compressed at the first rate and outputting a dequantized LPC filter parameter; and
quantizing the dequantized LPC filter parameter at the second rate and outputting an LPC bit stream at the second rate.

17. The method of claim 13, wherein the second element comprises a codebook parameter.

18. The method of claim 17, wherein the PCM-level rate conversion step comprises the steps of:
generating a codebook target signal using the codebook parameter at the first rate;
generating candidate signals corresponding to codebook parameters available for the second rate;
generating error signals by comparing the codebook target signal with the candidate signals; and
determining a codebook parameter corresponding to minimum error signals as a codebook parameter at the second rate.

19. An apparatus for converting the rate of a voice packet, comprising:
at least one first converter for converting the rate of at least one first element of an input voice packet compressed at a first rate into a second rate at a pulse code modulation (PCM) level; and
a second converter for converting the rate of a second element of the input voice packet into the second rate at a parameter level,
wherein the first element and second element at the second rate forms an output voice packet compressed at the second rate.

20. The apparatus of claim 19, wherein the first element comprises a pitch filter parameter.

21. The apparatus of claim 19, wherein the first element comprises a linear prediction coefficient (LPC) filter parameter.

22. The apparatus of claim 19, wherein the first converter comprises:
a dequantizer for dequantizing the first element of the input voice packet compressed at the first rate; and
a quantizer for quantizing the dequantized first element at the second rate and outputting the first element at the second rate.

23. The apparatus of claim 19, wherein the second element comprises a codebook parameter.

24. The apparatus of claim 23, wherein the second converter comprises:
a codebook target signal synthesizer for generating a codebook target signal using the codebook parameter at the first rate; and
a codebook parameter searcher for generating error signals by comparing the codebook target signal with candidate signals corresponding to codebook parameters available for the second rate, and determining a codebook parameter that corresponds to minimum error signals as a codebook parameter at the second rate.
